(19) United States
(12) Patent Application Publication
(10) Pub. No.: US 2026/0017852 A1
(43) Pub. Date: Jan. 15, 2026

(54) HEATMAP GENERATION METHOD AND APPARATUS, COMPUTER DEVICE AND STORAGE MEDIUM

(71) Applicant: BOE Technology Group Co., Ltd., Beijing (CN)

(72) Inventor: Xuhao CAO, Beijing (CN)

(21) Appl. No.: 18/995,252

(22) PCT Filed: Jan. 16, 2023
(86) PCT No.: PCT/CN2023/072282

§ 371 Date: Jan. 16, 2025

(51) Int. Cl. G06T 11/20; G06T 7/90; G06T 11/00

(52) U.S. Cl. CPC G06T 11/206; G06T 7/90; G06T 11/001; G06T 2207/10024

(57) ABSTRACT

The present disclosure provides a heatmap generation method, a heatmap generation apparatus, a computer device and a storage medium, belongs to the field of heatmap generation technology, and the heatmap generation method includes: acquiring an actual coordinate in a scene coordinate system and a pre-stored base heatmap; converting the actual coordinate into a pixel coordinate to obtain a target pixel point; clustering the target pixel point to obtain a target cluster, and generating category attribute information of the target cluster; and generating a rendering image of the target pixel point on the base heatmap according to parameter information configured for respective categories in advance and the category attribute information of the target cluster to obtain the heatmap.

### TECHNICAL FIELD

The present disclosure relates to the field of heatmap generation technology, in particular to a heatmap generation method, a heatmap generation apparatus, a computer device and a storage medium.

### BACKGROUND

A heatmap is a common map for displaying a distribution of hot spot data in a special highlight form and is, for example, used to show a cluster degree of visitors in an area, and an area with a greatest number of visitors over a period of time and the like. In general, in a process of generating the heatmap, a coordinate and a numerical value (such as the number of people represented by a given point) of the point are obtained, and then, a transparent circle with a linear gradient is drawn by taking the coordinate as a center of the circle, taking a size, which is user-specified or has a default value of a pixel as a radius, and taking a result of dividing the value (the number of people) of the point by a maximum value (maximum number of people) among all points as transparency. Then different colors are rendered for different transparencies through a certain user-specified or default fixed color matching scheme.

However, in the heatmap generated in the above manner, the transparent circle with the linear gradient results in a light color in the display picture and a poor display effect. In addition, with the certain user-specified or default fixed color matching scheme, in a case where two circles are close to each other, such as intersect with each other, a color change at the intersection of the two circles is not obvious, and the overall display effect is blurred.

### SUMMARY

The present disclosure is directed to solve at least one of the technical problems in the prior art, and provides a heatmap generation method, a heatmap generation apparatus, a computer device and a storage medium.

In a first aspect, a technical solution of the present disclosure adopted for solving the technical problems is a heatmap generation method, including: acquiring an actual coordinate in a scene coordinate system and a pre-stored base heatmap; converting the actual coordinate into a pixel coordinate to obtain a target pixel point; clustering the target pixel point to obtain a target cluster, and generating category attribute information of the target cluster; and generating a rendering image of the target pixel point on the base heatmap according to parameter information configured for respective categories in advance and the category attribute information of the target cluster to obtain a heatmap.

In some implementations, the clustering the target pixel point to obtain a target cluster and generating category attribute information of the target cluster includes: determining a clustering condition of each target pixel point according to a predetermined coordinate conversion ratio and a preset clustering factor; and classifying the target pixel point according to the clustering condition, to obtain the target cluster and generating the category attribute information of the target cluster.

In some implementations, the classifying the target pixel point according to the clustering condition to obtain the target cluster includes: taking one target pixel point as a core pixel point, and judging whether there is another target pixel point existed in a coverage range of the core pixel point; wherein the coverage range is determined based on the predetermined coordinate conversion ratio and the preset clustering factor; and taking another target pixel point as an updated core pixel point to traverse until no another target pixel point exists in the coverage range of the updated core pixel point under the condition that there is another target pixel point existed in the coverage range of the core pixel point; and clustering the respective core pixel points in the traversal process into a same target cluster.

In some implementations, the generating the category attribute information of the target cluster includes: generating the category attribute information of the target cluster according to the number of target pixel points in the target cluster.

In some implementations, the parameter information configured for the respective categories in advance includes category color matching information and rendering range information; the generating a rendering image of the target pixel point on the base heatmap according to parameter information configured for the respective categories in advance and the category attribute information of the target cluster to obtain the heatmap includes: generating, in response to that an actual representation range of the base heatmap meets a preset condition and based on the category attribute information of the target cluster, the rendering image of the target pixel point on the base heatmap according to the category color matching information and the rendering range information configured for the respective categories in advance to obtain the heatmap.

In some implementations, the generating, based on the category attribute information of the target cluster, the rendering image of the target pixel point on the base heatmap according to the category color matching information and the rendering range information configured for the respective categories in advance to obtain the heatmap includes: generating color matching mapping information corresponding to the respective categories according to the category color matching information configured for the respective categories in advance; determining the rendering range of the target pixel point according to the rendering range information configured for the respective categories in advance; determining, for the rendering range of the target pixel point, a rendering parameter of the pixel point in the rendering range according to a distance between the pixel point in the rendering range and the target pixel point and the rendering range information of the category corresponding to the target pixel point; and generating, based on the category attribute information of the target cluster, the rendering image of the target pixel point on the base heatmap according to the rendering parameter of the pixel point in the rendering range of the target pixel point and the color matching mapping information corresponding to the respective categories to obtain the heatmap.

In some implementations, the rendering parameter includes a transparency; the determining, for the rendering range of the target pixel point, the rendering parameter of the pixel point in the rendering range according to a distance between each pixel point in the rendering range and the target pixel point and the rendering range information of the category corresponding to the target pixel point includes: determining, for the rendering range of the target pixel point, the transparency of the pixel point in the rendering range by using a preset formula according to the distance between the pixel point in the rendering range and the target pixel point and the rendering range information of the category corresponding to the target pixel point; where the transparency of the pixel point in the rendering range is non-linearly changed as the distance between the pixel point and the target pixel point; a difference in transparency between two adjacent pixels close to the target pixel point and having different distances from the target pixel point is smaller than that between two adjacent pixels far from the target pixel point and having different distances from the target pixel point.

In some implementations, the generating the rendering image of the target pixel point includes: generating a sub-pixel value of the pixel point in the rendering range of the target pixel point according to the color matching mapping information of the category corresponding to the target pixel point; and generating the rendering image of the target pixel points according to the sub-pixel value and the rendering parameter of the pixel point in the rendering range of the target pixel point.

In some implementations, the parameter information configured for the respective categories in advance includes category color matching information and rendering range information; the heatmap generation method further includes: determining a scaling factor in response to a scaling operation to the base heatmap, and determining whether an actual representation range of the scaled base heatmap meets a preset condition or not; the generating the rendering image of the target pixel point on the base heatmap according to parameter information configured for the respective categories in advance and the category attribute information of the target cluster to obtain the heatmap includes: updating the rendering range information configured for the respective categories in advance and the pixel coordinate of the target pixel point according to the scaling factor in response to that the actual representation range of the scaled base heatmap meets the preset condition; and generating, based on the category attribute information of the target cluster, an updated rendering image of each target pixel point on the base heatmap according to the category color matching information configured for the respective categories in advance, the updated rendering range information of the respective categories and the updated pixel coordinate of the target pixel point to obtain the heatmap.

In some implementations, the heatmap generation method further includes: updating, in response to that an actual representation range of the base heatmap does not meet the preset condition, the rendering range information of the target pixel point according to the actual representation range of the base heatmap; and generating the rendering image of the target pixel point on the base heatmap according to the updated rendering range information of the target pixel point and the preset color matching information of the target pixel point to obtain the heatmap.

In some implementations, the updating the rendering range information of the target pixel point according to the actual representation range of the base heatmap includes: acquiring a plurality of preset specific representation ranges of the base heatmap and the rendering range information of the target pixel point corresponding to the respective specific representation ranges; selecting a part of specific representation ranges related to the actual representation range of the base heatmap from the specific representation ranges as a target representation range, and using the rendering range information corresponding to the target representation range as target rendering range information; determining a linear interpolation parameter according to the target representation range and the target rendering range information; and updating the rendering range information of the target pixel point according to the linear interpolation parameter and the actual representation range of the base heatmap.

In some implementations, the parameter information configured for the respective categories in advance includes category color matching information and rendering range information; the generating a rendering image of the target pixel point on the base heatmap according to parameter information configured for the respective categories in advance and the category attribute information of the target cluster to obtain the heatmap includes: updating, in response to that an actual representation range of the base heatmap does not meet a preset condition, the rendering range information of the target pixel point according to the actual representation range of the base heatmap; and generating the rendering image of each target pixel point on the base heatmap according to the updated rendering range information of the target pixel point and the category color matching information configured for the respective categories in advance to obtain the heatmap.

In some implementations, the converting the actual coordinate into a pixel coordinate to obtain target pixel point includes: determining a coordinate conversion ratio according to a calibration area in the real scene and a pre-stored coordinates of the calibration area; and obtaining the target pixel point according to the coordinate conversion ratio and the actual coordinate.

In a second aspect, an embodiment of the present disclosure further provides a heatmap generation apparatus, including: an information acquisition module configured to acquire an actual coordinate in a scene coordinate system and a pre-stored base heatmap; a first determining module configured to convert the actual coordinate into a pixel coordinate to obtain a target pixel point; a second determining module configured to cluster the target pixel point to obtain a target cluster, and generate category attribute information of the target cluster; and a processing module configured to generate a rendering image of the target pixel point on the base heatmap according to parameter information configured for the respective categories in advance and the category attribute information of the target cluster to obtain a heatmap.

In a third aspect, an embodiment of the present disclosure further provides a computer device, including: a processor, a memory and a bus, where the memory stores machine-readable instructions executable by the processor; the processor and the memory are communicated with each other over the bus when the computer device is operating; the machine-readable instructions, when executed by the processor, perform the steps of the heatmap generation method in any one of the above embodiments.

In a fourth aspect, an embodiment of the present disclosure further provides an non-transitory computer readable storage medium, where the non-transitory computer readable storage medium has stored thereon a computer program, which, when executed by a processor, performs the steps of the heatmap generation method in any one of the above embodiments.

### BRIEF DESCRIPTION OF DRAWINGS

FIG. 1 is a schematic diagram of a conventional rendered image;

FIG. 2 is a flowchart of a heatmap generation method according to an embodiment of the present disclosure;

FIG. 3 is a schematic diagram of a scene picture captured by a camera according to an embodiment of the present disclosure;

FIG. 4 is a schematic diagram of a rendered image according to an embodiment of the present disclosure;

FIG. 5 is a schematic diagram of an exemplary color matching mapping table according to an embodiment of the present disclosure;

FIG. 6 is a schematic diagram of an overall flow for generating a heatmap according to an embodiment of the present disclosure;

FIG. 7 is a schematic diagram of a heatmap generation apparatus according to an embodiment of the present disclosure; and

FIG. 8 is a schematic diagram of a structure of a computer device according to an embodiment of the present disclosure.

### DETAIL DESCRIPTION OF EMBODIMENTS

To make the objects, technical solutions and advantages of the embodiments of the present disclosure more apparent, the technical solution of the embodiments of the present disclosure will be clearly and completely described below with reference to the drawings of the embodiments of the present disclosure. It is to be understood that the described embodiments are only a few, not all of, embodiments of the present disclosure. Components of the embodiments of the present disclosure, as generally described and illustrated in the drawings herein, could be arranged and designed in a wide variety of different configurations. Thus, the following detailed description of the embodiments of the present disclosure in the drawings is not intended to limit the claimed scope of the present disclosure, but is merely representative of selected embodiments of the present disclosure. All other embodiments, which can be derived by a person skilled in the art from the embodiments of the present disclosure without any creative effort, are within the scope of the present disclosure.

Unless defined otherwise, technical or scientific terms used herein shall have the ordinary meaning as understood by one of ordinary skill in the art to which the present disclosure belongs. The terms “first”, “second”, and the like used in the present disclosure are not intended to indicate any order, quantity, or importance, but rather are used for distinguishing one element from another. Further, the term “a”, “an”, “the”, or the like used herein does not denote a limitation of quantity, but rather denotes the presence of at least one element. The term of “comprising/comprise”, “including/include”, or the like, means that the element or item preceding the term contains the element or item listed after the term and its equivalent, but does not exclude other elements or items. The term “connected/connecting”, “coupled/coupling”, or the like is not limited to physical or mechanical connections, but may include electrical connections, whether direct or indirect connections. The terms “upper”, “lower”, “left”, “right”, and the like are used only for indicating relative positional relationships, and when the absolute position of an object being described is changed, the relative positional relationships may also be changed accordingly.

Reference to “a plurality or a number” in the present disclosure means two or more. Reference to “and/or” describes association relationships among associated objects, indicating that there may be three relationships. For example, A and/or B may indicate: A alone, A and B, or B alone. The character “/” generally indicates that the associated objects before and after the “/” are in an “or” relationship.

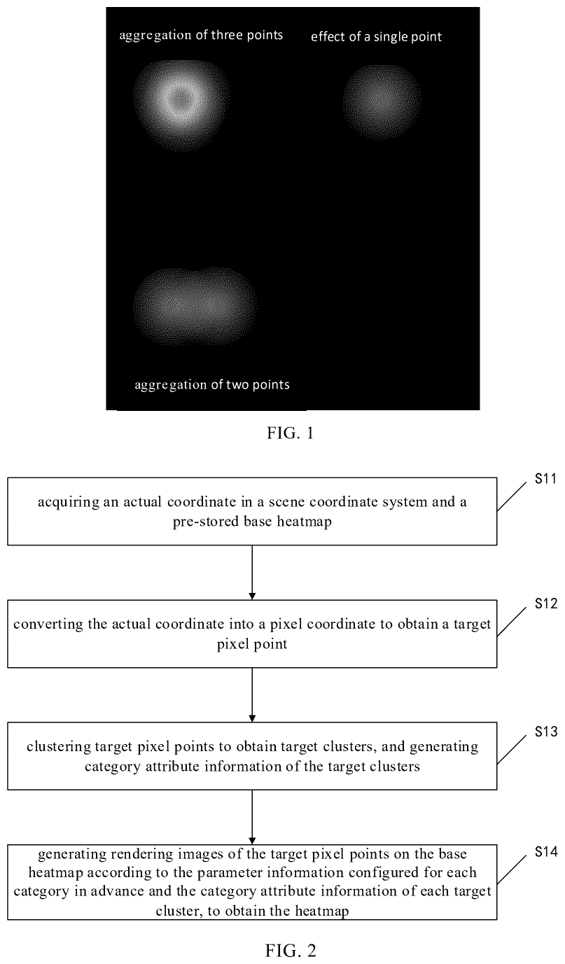

In the related art, in a process of generating the heatmap, a coordinate and a numerical value (such as the number of people represented by a given point) of the point are obtained, and then, a transparent circle with a linear gradient is drawn by taking the coordinate as a center of the circle, taking a size, which is user-specified or has a default value of a pixel as a radius, and taking a result of dividing the value (the number of people) of the point by a maximum value (maximum number of people) among all points as transparency. Then different colors are rendered for different transparencies through a certain user-specified or default fixed color matching scheme. For example, green is displayed when the transparency is 25%, yellow is displayed when the transparency is 50%, and red is displayed when the transparency is 75% (the smaller the value of the transparency is, the higher the transparency is, and the more blurred the display effect is). However, the heatmap generated in the above manner has the following problems: 1) when the value of the point is small, for example, the maximum value of the point is 10, the point with the value of 5 has only a transparency of 50%, which results in a light color in the display picture and a poor display effect, the specific effect is shown as the effect of a single point in FIG. 1; 2), when the values of the points are the same, for example, each point represents one person, a color change at an intersection of two points close to each other is not obvious, which results in a poor effect, if the value of the transparency required for the corresponding color is reduced, the color change at the intersection is improved compared to the original one, but is still not obvious, and the specific effect is shown by aggregation of two points in FIG. 1, and If the value of the transparency is significantly reduced, the display effect may be obvious, but a preset configuration requirement will not be met, for example, it is required that yellow is displayed with two points intersecting with each other, and red is displayed with three or more points intersecting with each other, but red is displayed with two points intersecting with each other due to the reduced transparency, so that the configuration requirement is not met; 3), when a scale of a base map is reduced, a wider space is displayed, for example, only a street may be initially displayed on a screen, and the whole development area may be displayed when the scale is reduced, if a heat point with a fixed radius of pixel is adopted, an actual meaning of a coverage range of the heat point is increased, which results in inaccurate information, if a heat point with a radius changing with a default function of f(x)=2^{x} is adopted, when the scale is reduced, the heat point cannot be displayed on the map due to a too small radius; or when the scale is enlarged, the radius of the heat point is too large, which causes distortion.

Based on this, in order to solve one or more of the above technical problems, the embodiments of the present disclosure provide a heatmap generation method, which includes: obtaining a heatmap by acquiring actual coordinates in a scene coordinate system and a pre-stored base heatmap; converting the actual coordinates into pixel coordinates to obtain target pixel points; clustering the target pixel points to obtain a target cluster and generating category attribute information of the target cluster; and generating rendering images of the target pixel points on the base heatmap according to parameter information configured for each category in advance and the category attribute information of each target cluster.

In the embodiment of the present disclosure, different rendering modes are configured for different groups (clusters) for rendering in groups (clusters). That is, target pixel points in different target clusters are rendered by different rendering modes according to the parameter information configured for each category in advance, so that the generated heatmap is more attractive and flexible in configuration.

Specific steps of a method for generating a heatmap according to an embodiment of the present disclosure are explained in detail below. FIG. 2 is a flowchart of a method for generating a heatmap according to an embodiment of the present disclosure. As shown in FIG. 2, the method includes steps S11 to S14.

At step S11, acquiring an actual coordinate in a scene coordinate system and a pre-stored base heatmap.

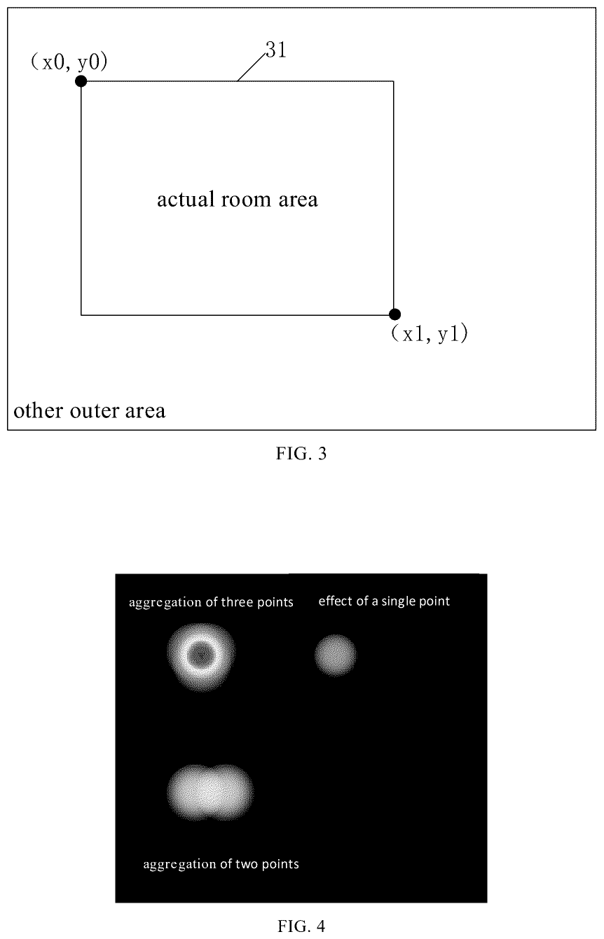

The actual coordinate is a coordinate of the target point in the scene coordinate system, and the scene coordinate system is a coordinate system in a pre-established real scene, for example, a coordinate system established from an image of the real scene captured by a capturing device. The coordinate of the target point in the real scene is pre-stored in a data storage medium (for example, a media such as a database or a message queue), and may be obtained from the data storage medium when a heatmap generation algorithm is started. FIG. 3 is a schematic diagram of an image of scene captured by a camera according to an embodiment of the present disclosure. As shown in FIG. 3, the image of scene includes an actual room area 31, a coordinate of an upper left corner of the actual room area 31 is (x0, y0) and a coordinate of a lower right corner of the actual room area 31 is (x1, y1), and the room has an actually offline measured width denoted as width and a length denoted as high. The actual coordinate within the actual room area 31 is denoted as (x_{actual coordinate}, y_{actual coordinate}).

The base heatmap here may be a canvas of a heatmap visualization library heatmap.js, or an indoor scalable map or the like. The base heatmap may also be obtained from the data storage medium.

At step S12, converting the actual coordinate into a pixel coordinate to obtain a target pixel point.

In a possible implementation, the actual coordinate may be converted into the pixel coordinate according to a known mapping relationship between the scene coordinate system and a pixel coordinate system, so that the target pixel points are obtained. The target pixel point is a pixel to be displayed.

In another possible implementation, a coordinate conversion ratio is determined according to a calibration area in the real scene and a pre-stored coordinate thereof, and the target pixel point is obtained according to the coordinate conversion ratio and the actual coordinate.

As shown in FIG. 3, the calibration area in the real scene is the real room area 31. Pre-stored coordinates of the calibration area are, for example, (x0, y0) of the upper left corner and (x1, y1) of the lower right corner. In order to avoid an error between a measured value and a true value, an abscissa and an ordinate in each coordinate are calculated by using different coordinate conversion ratios. In specific implementation, the coordinate conversion ratio is a ratio of a dimension on the image to an actual dimension, where (x1−x0) is the dimension on the image, and the width is the actual dimension, and the x_{actual coordinate} in the actual coordinate (x_{actual coordinate}, y_{actual coordinate}) is converted into an x_{pixel coordinate} in the pixel coordinate (x_{pixel coordinate}, y_{pixel coordinate}), that is:

$${x}_{pixel coordinate} = {x}_{a c tual coordinate} \times \frac{( x 1 - x 0 )}{width} + x 0$$

The coordinate conversion ratio is the ratio of the dimension on the image to the actual dimension, where (y1−y0) is the dimension on the image and high is the actual dimension, and the y_{actual coordinate} in the actual coordinate (x_{actual coordinate}, y_{actual coordinate}) is converted into a y_{pixel coordinate} in the pixel coordinate (x_{pixel coordinate}, y_{pixel coordinate}), that is:

$${y}_{pixel coordinate} = {y}_{a c tual coordinate} \times \frac{( y 1 - y 0 )}{high} + y 0$$

At step S13, clustering the target pixel points to obtain target clusters, and generating category attribute information of the target clusters.

Specifically, the target pixel points may be clustered by using a clustering algorithm to obtain the target clusters. For the obtained target clusters, the category attribute information of the target clusters may be generated according to the number of the target pixel points in each target cluster. For example, the category attribute information may be identity information characterizing the category of the target cluster, such as an identity id or the like. The category attribute information of the target cluster is the category attribute information of each target pixel point in the target cluster.

Illustratively, the clustering algorithm may be, for example, a dbScan density clustering algorithm, which may cluster a dense data set of arbitrary shape.

At step S14, generating rendering images of the target pixel points on the base heatmap according to the parameter information configured for each category in advance and the category attribute information of each target cluster, to obtain the heatmap.

Here, the parameter information configured for each category in advance may include category color matching information configured for each category in advance and/or rendering range information configured for each category in advance, and the like. The category color matching information may be a color matching scheme provided for the rendering process of the target pixel points; the rendering range information may be a rendering range parameter provided for the rendering process of the target pixel points.

In the embodiment of the present disclosure, different rendering modes are configured for different groups (clusters) for rendering in groups (clusters). The rendering images corresponding to the target pixel points are generated on the heatmap according to the category attribute information of each target cluster, i.e., the category attribute information of the target pixel points, and according to the parameter information configured for each category in advance, so that the generated heatmap is more attractive and the rendering mode is flexible in configuration.

Illustratively, when two target pixel points are close to each other, the two target pixel points are classified into the same category (the same target cluster) through the clustering algorithm. The target pixel points in the same target cluster are labeled with the same category attribute information. By taking an example in which green is displayed when the original transparency is 50%, yellow is displayed when the original transparency is 75%, and red is displayed when the original transparency is 100%, the effect of a image drawn by directly using the original heatmap visualization library heatmap.js is shown as aggregation of two points in FIG. 1. The specific effect for the improved target cluster with two target pixel points aggregated together is shown, by taking an example in which green is displayed when the transparency is 30%, and yellow is displayed when the transparency is 83%, as the aggregation of two points in FIG. 4. It can be seen that for the aggregation of the two points in FIG. 4, the color of the aggregated part occupies a large proportion, and it can be obviously recognized that there are two independent target pixel points close to each other in this part, and thus, the visual effect of the heatmap is better. The specific effect for the improved target cluster composed of separated target pixel points is shown, by taking an example in which green is displayed when the transparency is 83%, as the single point in FIG. 4. It can be seen that the brightness of the single point in FIG. 4 is obviously higher than that of FIG. 1. In FIG. 4, the rendering range information of different categories is configured by clustering, so that the rendering range in the case of the single point is smaller than that in the case of target clusters, and the visual effect is better.

In some implementations, in the step S13, a clustering condition of the target pixel points may be determined according to the predetermined coordinate conversion ratio and a preset clustering factor; and then, the target pixel points are classified according to the clustering condition, to obtain the target clusters, and the category attribute information of each target cluster is generated.

Here, the coordinate conversion ratio is known, and

$$\frac{( x 1 - x 0 )}{width} and \frac{( y 1 - y 0 )}{high}$$

are also known. According to the preset clustering factor a, for example, target pixel points with a meters spacing therebetween are classified into a category, and correspondingly, the spacing is converted into a spacing of

$$a \times \frac{( x 1 - x 0 )}{width} or a \times \frac{( y 1 - y 0 )}{high}$$

in the pixel coordinate system. Because the coordinate conversion ratios of

$$\frac{( x 1 - x 0 )}{width} and \frac{( y 1 - y 0 )}{high}$$

each have errors, in order to adopt the more accurate coordinate conversion ratios as much as possible, the spacing between two target pixel points that is converted into the pixel coordinate system is set as

$$t = a \times Max ( \frac{x 1 - x 0}{width} , \frac{y 1 - y 0}{high} ) .$$

That is, the clustering condition of the target pixel points is: the target pixel points can be aggregated into a same cluster in the pixel coordinate system, and it is ensured that the spacing between two target pixel points is less than

$$t = a \times Max ( \frac{x 1 - x 0}{width} , \frac{y 1 - y 0}{high} ) .$$

The t may be used to determine a coverage range of the target pixel points.

Then, the target pixel points are sequentially traversed according to the clustering condition to determine the target clusters to which the target pixel points belong.

In some implementations, the step of the target pixel points being sequentially traversed according to the clustering condition to determine the target clusters to which the target pixel points belong specifically includes: taking one target pixel point as a core pixel point, and judging whether another target pixel point exists in a coverage range of the core pixel, where, the coverage range is determined based on the predetermined coordinate conversion ratio and the preset clustering factor; in a case where another target pixel point exists in the coverage range of the core pixel, taking the another target pixel point as an updated core pixel point and continuing to sequentially traverse the core pixel points until no other target pixel point exists in the coverage range of the updated core pixel; and clustering the core pixels in the traversal process into a same target cluster.

For example, t may be a radius of the coverage range of the core pixel point, or a side length of the coverage range. For example, a circular area is determined by taking t as the radius thereof and taking the core pixel point as a center thereof, and is used as the coverage range of the core pixel point. For another example, a square area is determined by taking t as a side length thereof and taking the core pixel point as a geometric center thereof, and is used as the coverage range of the core pixel point.

All pixel points may be clustered by using the dbScan clustering algorithm. The processing by using the dbScan algorithm mainly includes the following steps: firstly, arbitrarily taking a target pixel point A, which is not clustered, as a core pixel A, detecting whether another target pixel point B exists in a coverage range of the core pixel point A; if there is a target pixel point B exists in the coverage range of the core pixel point A, recording (labeling) the target pixel point B and the core pixel A as a same category; and taking the target pixel point B as an updated core pixel point B, and detecting whether another target pixel point C which is not clustered exists in a coverage range of the updated core pixel point B, then traversing the target pixel points in this way until no target pixel point exists in the coverage range of the updated core pixel point, and clustering the core pixel points (A and B, or A, B and C) in the traversing process into a same target cluster.

In some implementations, the category attribute information of the target cluster may be generated according to the number of target pixel points in the target cluster. Exemplarily, if only one target pixel point exists in the target cluster, the category attribute information of the target cluster is determined to be id=1; if only two target pixel points exist in the target cluster, the category attribute information of the target cluster is determined to be id=2; and if the number of the target pixel points in the target cluster is more than or equal to three, the category attribute information of the target cluster is determined to be id=3. Alternatively, one of ordinary skill in the art may define the category attribute of the target cluster according to an actual situation, or may add the category attribute information, for example, id=4 or id=5, and specific examples thereof are not enumerated.

The steps S11 to S13 in the embodiment of the present disclosure may specifically be performed by using a backend device, and the step S14 is performed by using a front-end device. The backend device sends the obtained category attribute information of the target cluster and the pixel coordinates of the target pixel points in the target cluster to the front-end device for image rendering. Specifically, the front-end device may actively initiate a network request to obtain relevant data. Alternatively, the backend device may actively push the relevant data to a processor of the front-end device, which is not limited in the present disclosure.

In some implementations, with respect to step S14, in particular, the parameter information configured for each category in advance includes the category color matching information and the rendering range information. In a case where an actual representation range of the base heatmap meets a preset condition, the rendering images of the target pixel points are generated, based on the category attribute information of each target cluster, on the base heatmap according to the category color matching information and the rendering range information configured for each category in advance to obtain the heatmap.

Here, the category color matching information may be a color matching scheme provided for the rendering process of the target pixel points; the rendering range information may be a rendering range parameter provided for the rendering process of the target pixel points.

Here, the preset condition may be a preset judgment condition of the base heatmap. For example, the base heatmap may be a scalable map, a canvas of heatmap.js or an indoor scalable map or the like. The scalable map has different actual representation ranges represented by the map, which may be represented by the number of layers, such as one layer to nineteen layers. The smaller the number of layers, the larger the actual representation range of the map. The base heatmap includes three layers, and represents a worldwide map; the base heatmap includes nineteen layers, and represents a map of a street area. The actual representation range represented by the indoor scalable map may correspond to twenty layers.

The preset condition in the embodiment of the present disclosure may be a condition that the actual representation range of the base heatmap is not in a range from one layer to nineteen layers. Therefore, if the base heatmap is a canvas of heatmap. js or an indoor scalable map, it can be determined that the current base heatmap meets the preset condition, and then, the category color matching information and the rendering range information configured for each category in advance may be adopted in a targeted manner to generate, according to the category attribute information of each target cluster, the rendering images of the target pixel points on the base heatmap, so as to obtain the heatmap.

In some implementations, in a case where the actual representation range of the base heatmap meets the preset condition, the rendering images of the target pixel points are generated on the base heatmap to obtain the heatmap, which can specifically refer to following steps S141 to S144.

At step S141, generating color matching mapping information corresponding to each category according to the category color matching information configured for each category in advance.

Illustratively, it is known that the category attribute information of the target cluster obtained by clustering includes id=1, id=2, and id=3. In the category color matching information configured for the three categories in advance, the category color matching information configured with id=1 includes displaying green when the transparency is 0.83; the category color matching information configured with id=2 includes displaying when the transparency is 0.3 and displaying yellow when the transparency is 0.83; the category color matching information configured with id=2 includes displaying green when the transparency is 0.83, displaying yellow when the transparency is 0.97 and displaying red when the transparency is 0.995. Then, color information corresponding to each transparency is determined and the color matching mapping information corresponding to each category is generated based on the category color matching information of each category and according to a linear relationship between the transparency and the color.

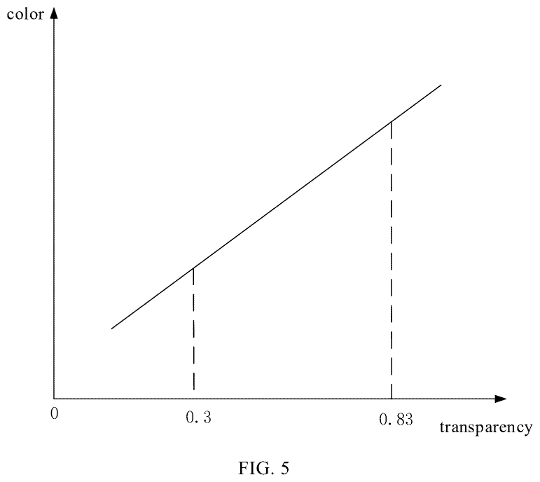

Taking the category color matching information with id=2 as an example, there is a linear relationship between the transparency of 0.3 and a pixel value RGB of green, and between the transparency of 0.83 and a pixel value RGB of yellow. Based on this, an association relationship between any transparency and a pixel value may be determined, thereby obtaining the color matching mapping information corresponding to the category configured with id=2. FIG. 5 is a schematic diagram of an exemplary color matching mapping table according to an embodiment of the present disclosure. FIG. 5 specifically shows a color matching mapping table (i.e., the color matching mapping information) corresponding to the category with id=2. A pixel value corresponding to any transparency is included in the table, so that a color corresponding to any transparency of the category with id=2 may be determined.

Similarly, the generation process of the color matching mapping tables corresponding to the categories with id=1 and id=3 may refer to that of the color matching mapping table corresponding to the category with id=2, and repeated descriptions are omitted.

At step S142, determining the rendering range of each target pixel point according to the rendering range information configured for each category in advance.

Illustratively, it is known that the category attribute information of the target cluster obtained by clustering includes id=1, id=2, and id=3. In the rendering range information configured for the three categories in advance, the rendering range information configured for id=1 is 31×0.75, the rendering range information configured for id=2 is 31, the rendering range information configured for id=3 is 31×1.25, the unit is the number of pixels, and for decimal numbers, the decimal numbers may be rounded to the left or the right. Taking the category color matching information with id=2 as an example, the rendering range information is 31 pixels, and a circular area formed by taking the parameter (the rendering range information being 31 pixels) as a radius and a target pixel point as a center of a circle may be used as the rendering range of the target pixel point. Alternatively, a square area formed by taking the parameter (the rendering range information being 31 pixels) as a side length and the target pixel point as a geometric center may be used as the rendering range of the target pixel point, or the like.

At step S143, for the rendering range of each target pixel point, determining a rendering parameter of each pixel point in the rendering range according to a distance between each pixel point and the target pixel point in the rendering range and the rendering range information of the category corresponding to the target pixel point.

Here, the rendering parameter may be the transparency.

In some implementations, for the rendering range of each target pixel point, the transparency of each pixel point in the rendering range may be determined by using a preset formula according to the distance between each pixel point and the target pixel point in the rendering range and the rendering range information of the category corresponding to the target pixel point.

Taking one target pixel point Q of the target pixel points as an example, the rendering range of the target pixel point Q includes a plurality of pixel points P, and the distance between each of the pixel points P and the target pixel point Q may be an euclidean distance, denoted by b. Taking the rendering range as a circular range as an example, the rendering range information is used as a radius r of the circular range, and a transparency Alpha of each pixel point in the rendering range is determined according to the following preset formula:

$$Alpha = 1 - {( \frac{b}{r} )}^{3}$$

where, b∈[0,r], Alpha∈[0,1]. The transparency Alpha of the target pixel point is 1, that is, the target pixel point is completely opaque.

Here, it can be known according to the preset formula that the transparency of the pixel point in the rendering range is non-linearly changed as the distance between the pixel point and the target pixel point (i.e., the center of the circular area). Specifically, a difference in transparency between two adjacent pixel points close to the target pixel point and having different distances from the target pixel point is smaller than a difference in transparency between two adjacent pixel points far from the target pixel point and having different distances from the target pixel point.

In the embodiment of the present disclosure, a gradual change mode of the transparency in the rendering process is changed from a linear gradual change mode to a non-linear gradual change mode, so that a descent speed of the transparency of the pixel point close to the center of the circle is reduced, and the opacity of the whole circle is improved; and the opacity of the overlapped part of the plurality of target pixel points close to each other is improved, so that the color of the entire heatmap obtained by rendering is brighter and clearer, and the color of the overlapped part is the main color of the whole rendering image when a plurality of circles intersect with each other (that is, the plurality of target pixel points are close to each other).

In some implementations, other non-linear transformation formulas may be adopted, as long as it satisfies Alpha∈[0,1] and b∈[0,r], and the formula being a decreasing function can also achieve the above effect to a certain extent and is superior to the linear gradual change mode of the transparency in effect.

At step S144, generating, based on the rendering parameter of each pixel point in the rendering range of each target pixel point and the color matching mapping information corresponding to each category, the rendering images of the target pixel points on the base heatmap according to the category attribute information of each target cluster, to obtain the heatmap.

In a specific implementation, a sub-pixel value of each pixel point in the rendering range of the target pixel point may be generated according to the color matching mapping information of the category corresponding to the target pixel point. Taking one target pixel point as an example, the other target pixel points are rendered in the same way. The transparency of each pixel point within the rendering range of the target pixel point Q is known, and the sub-pixel value, including a red sub-pixel value R, a green sub-pixel value G, and a blue sub-pixel value B, of each pixel point is determined from the color matching mapping information (as shown in FIG. 5) generated in step S141 according to the transparency of each pixel point. Then, the rendering image of the target pixel point is generated according to the sub-pixel value and the rendering parameter of each pixel point in the rendering range of the target pixel point. That is, the rendering image of the target pixel point in the rendering range thereof is determined according to the parameters including R, G, B, Alpha of each pixel point. The rendering image of each target pixel point in the rendering range thereof is generated on the base heatmap, thereby obtaining the heatmap.

In the above steps S141 to S144, different color rendering modes and different rendering ranges are adopted for the target pixel points in different target clusters, so that the visual effect of the rendering images is better, details may refer to a comparison between FIG. 1 and FIG. 2 or a comparison between FIG. 1 and FIG. 3. In addition, in a rendering range, the closer the pixel point is to the target pixel point, the slower the descent speed of the transparency of the pixel point is, so that the overall opacity of the rendering range is improved; and the opacity of the overlapped part of the plurality of target pixel points close to each other is improved, so that the color of the entire heatmap obtained by rendering is brighter and clearer.

In some implementations, the heatmap generation method further includes: determining, in response to a scaling operation for the base heatmap, a scaling factor, and determining whether the actual representation range of the scaled base heatmap meets the preset condition or not. Here, the base heatmap supports the scaling operation; and in response to the scaling operation for the base heatmap by a user, for example, the scaling operation may be to scale down the base heatmap by 2 times, in this case, the scaling factor is ½; if the base heatmap is scaled up by 2 times, the scaling factor is 2. A scaled base heatmap is obtained by multiplying the original base heatmap by the corresponding scaling factor.

For example, if the actual representation range of the scaled base heatmap is not between one layer and nineteen layers, it may be determined that the scaled base heatmap meets the preset condition; otherwise, if the actual representation range of the scaled base heatmap is between one layer and nineteen layers, it can be determined that the scaled base heatmap does not meet the preset condition.

In some implementations, in a case where the actual representation range of the scaled base heatmap meets the preset condition, the rendering range information configured for each category in advance and the pixel coordinate of each target pixel point are updated according to the scaling factor. For example, the updated pixel coordinate of each target pixel point is obtained by multiplying the pixel coordinate of each target pixel point by the scaling factor; and the updated rendering range information corresponding to each category is obtained by multiplying a rendering range parameter r configured for each category in advance by the scaling factor.

Then, an updated rendering image of each target pixel point is generated on the base heatmap according to the category color matching information configured for each category in advance, the updated rendering range information of each category and the updated pixel coordinate of each target pixel point and based on the category attribute information of each target cluster, to obtain the heatmap.

In a specific implementation, a sub-pixel value of each pixel in the updated rendering range of the updated target pixel point may be generated according to the updated color matching mapping information of the category corresponding to the target pixel point. Taking one updated target pixel point as an example, the other target pixel points are rendered in the same way. The transparency of each pixel point within the updated rendering range of the updated target pixel point Q1 is known, and the sub-pixel value, including a red sub-pixel value R, a green sub-pixel value G, and a blue sub-pixel value B, of each pixel point is determined from the color matching mapping information (as shown in FIG. 5) according to the transparency of each pixel point. Then, the rendering image of the updated target pixel point is generated according to the sub-pixel value and the rendering parameter of each pixel point in the updated rendering range. That is, the rendering image of each updated target pixel point in the updated rendering range is determined according to the parameters including R, G, B, Alpha of each pixel point. The rendering image of each updated target pixel point in the updated rendering range is generated on the base heatmap, thereby obtaining the heatmap.

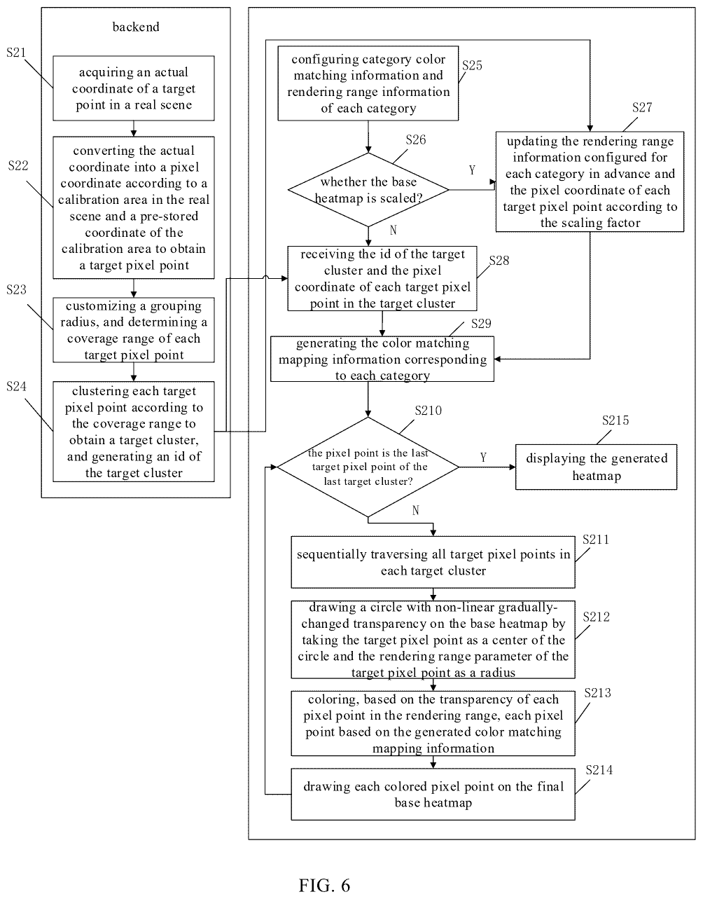

FIG. 6 is a schematic diagram of an overall flow for generating a heatmap according to an embodiment of the present disclosure. As shown in FIG. 6, firstly, the processing steps by the backend device include steps S21 to S24. At step S21, acquiring an actual coordinate of a target point in a real scene; at step S22, converting the actual coordinate into a pixel coordinate according to a calibration area in the real scene and a pre-stored coordinate of the calibration area to obtain a target pixel point; at step S23, specifying a grouping radius, and determining a coverage range of the target pixel point; and at step S24, clustering each target pixel point according to the coverage range to obtain a target cluster, and generating an id of the target cluster. Then, the obtained id of the target cluster and the pixel coordinate of each target pixel point in the target cluster are sent to the front-end device (specifically, to the steps S27 and S28 performed by the front-end device), and the processing steps performed by the front-end device include steps S25 to S215. At step S25, configuring category color matching information and rendering range information of each category; at step S26, judging whether the base heatmap is scaled, if yes, executing a step S27, and if not, executing a step S28; at step S27, updating the rendering range information configured for each category in advance and the pixel coordinate of each target pixel point according to the scaling factor, and continuing to execute the step S29; at step S28, receiving the id of the target cluster and the pixel coordinate of each target pixel point in the target cluster; at step S29, generating the color matching mapping information corresponding to each category; at step S210, judging whether the pixel point is the last target pixel point of the last target cluster, if so, executing a step S215, and if not, executing a step S211; at step S211, sequentially traversing all target pixel points in each target cluster; at step S212, drawing a circle with non-linear gradually-changed transparency on the base heatmap by taking the target pixel point as a center of the circle and the rendering range parameter of the target pixel point as a radius; at step S213, coloring, based on the transparency of each pixel point in the rendering range, each pixel point based on the generated color matching mapping information; and at step S214, drawing each colored pixel point on the final base heatmap, and returning to execute step S210; and at step S215, displaying the generated heatmap.

In some implementations, in a case where the actual representation range of the base heatmap does not meet the preset condition, the rendering range information of each target pixel point is updated according to the actual representation range of the base heatmap.

Here, the actual representation range of the base heatmap does not meet the preset condition, and it can be understood that the actual representation range of the base heatmap is between one layer and nineteen layers. Specifically, the original base heatmap may be scaled by a user, so that the actual representation range of the scaled base heatmap is between one layer and nineteen layers; or the actual representation range of the currently acquired base heatmap itself is between one layer and nineteen layers.

In a specific implementation, a mapping table between preset representation ranges of the base heatmap and the rendering range information corresponding to the representation ranges may be obtained; and then, according to the actual representation range L of the base heatmap, a rendering range information corresponding to the actual representation range L is selected from the mapping table as the updated rendering range information of each target pixel point.

Here, the actual representation range of the base heatmap is relatively large, that is, one to nineteen layers represent outdoor scenes, and at in this case, a distribution for indoor areas is not a focus, so that it is not necessary to perform the cluster rendering on the indoor target points. There is a new rendering manner as follows: generating the rendering image of each target pixel point on the base heatmap according to the updated rendering range information of each target pixel point and the preset color matching information of each target pixel point, to obtain the heatmap.

Here, the updated rendering range may be determined from the updated rendering range information.

Illustratively, corresponding color rendering schemes are set for different transparencies in advance. For example, displaying green when the transparency Alpha is 0.5, displaying yellow when the transparency Alpha is 0.75, and displaying red when the transparency Alpha is 1. Then, according to the color rendering schemes, the color information corresponding to each transparency is determined according to the linear relationship between the transparencies and the colors, and a color matching mapping table corresponding to each transparency is generated. Then, the sub-pixel value of each pixel point in the updated rendering range of the target pixel point may be determined according to the color matching mapping table. Taking one target pixel point as an example, other target pixel points are rendered in the same way. The transparency of each pixel point in the updated rendering range of the target pixel point Q2 is known, and the sub-pixel value, including a red sub-pixel value R, a green sub-pixel value G, and a blue sub-pixel value B, of each pixel is determined from the color matching mapping information according to the transparency of each pixel point. Then, the rendering image of the target pixel point Q2 in the updated rendering range may be determined according to the parameters including R, G, B, Alpha of each pixel point in the updated rendering range. The rendering image of the target pixel point in the updated rendering range is generated on the base heatmap, thereby obtaining the heatmap.

In some implementations, in a case where the actual representation range of the base heatmap does not meet the preset condition, the rendering range information of each target pixel point is updated according to the actual representation range of the base heatmap. Specifically, firstly, a plurality of preset specific representation ranges of the base heatmap and the rendering range information of the target pixel point corresponding to each specific representation range may be obtained; then, a part of specific representation ranges related to the actual representation range of the base heatmap is elected from the specific representation ranges as a target representation range, and the rendering range information corresponding to the target representation range is used as the target rendering range information; then, a linear interpolation parameter is determined according to the target representation range and the target rendering range information; and finally, the rendering range information of each target pixel point is updated according to the linear interpolation parameter and the actual representation range of the base heatmap.

Illustratively, the “specific representation range” may be, for example, three layers, twelve layers, nineteen layers. The rendering range parameter r1 of the base heatmap corresponding to the three layers is ten pixels, the rendering range parameter r2 of the base heatmap corresponding to the twelve layers is fifteen pixels, and the rendering range parameter r3 of the base heatmap corresponding to the nineteen layers is twenty pixels. Here, the base heatmap of one layer to nineteen layers is subjected to a linear segmentation processing, where the base heatmap is divided into the base heatmap with an actual representation range of one layer to three layers, the base heatmap an actual representation range of three to twelve layers, the base heatmap with an actual representation range of twelve to nineteen layers, and the base heatmap with an actual representation range of more than nineteen layers.

Taking the actual representation range of the base heatmap is eight layers as an example, the eight layers are between three layers and twelve layers, so that it is determined that the three layers and the twelve layers are the specific representation ranges related to the actual representation range, and thus, are used as target representation ranges. The rendering range information r1 of the base heatmap corresponding to the three layers is ten pixels, and the rendering range information r2 of the base heatmap corresponding to the twelve layers is fifteen pixels, and therefore, r1 and r2 are used as the target rendering range information. The linear interpolation parameter is determined with a linear interpolation algorithm according to the three layers, the twelve layers, the ten pixels and the fifteen pixels.

Here, the linear interpolation parameter includes β and γ; the calculation formulas (i.e., the linear interpolation algorithms) for β and γ are as follows:

$$β = \frac{R 2 - R 1}{L 2 - L 1}$$

$$γ = \frac{R 1 \times L 2 - R 2 \times L 1}{L 2 - L 1}$$

where R1 and R2 represent the target rendering range information, and L1 and L2 represent the target representation ranges.

The rendering range information of each target pixel point is updated according to the linear interpolation parameter and the actual representation range L of the base heatmap. The updated rendering range information R is determined according to the following interpolation formula:

$$R = β \times L + γ$$

Illustratively, the linear interpolation parameters determined for the base heatmap with the actual representation range of eight layers are

$$β = \frac{15 - 10}{12 - 3} = \frac{5}{9} and γ = \frac{10 \times 12 - 15 \times 3}{12 - 3} = \frac{75}{9} .$$

$$R = β \times L + γ = \frac{5}{9} \times 8 + \frac{75}{9} = \frac{115}{9} .$$

In the embodiment of the present disclosure, the interpolation formula of the base heatmap corresponding to each segment may be obtained by customizing the specific representation range of the base heatmap and the rendering range information corresponding to the specific representation range. For the rendering range information which is not set, for example, the rendering range information corresponding to the specific representation range of one layer is not configured, the rendering range information corresponding to the base heatmap with the representation range of one layer to three layers is determined by multiplexing interpolation formulas corresponding to the base heatmap with the representation range of three layers to twelve layers.

In the embodiment of the present disclosure, a change mode of the rendering range of the target pixel point is changed from an original fixed or exponential gradual change mode to the linear segmentation processing, so that the generated heatmap can keep a good display effect under respective scales, and the displayed information is more accurate. In addition, the rendering range information is subjected to the linear interpolation processing according to the embodiment of the present disclosure, the specific representation range can be set arbitrarily according to the configuration rule, and the rendering range information corresponding to the specific representation range is adjusted, so that when the scale is large and thus the rendering radius is increased, the target pixel points originally separated from each other can still be separated from each other. In a case where the scale is small, the minimum rendering radius of limiting the target pixel point is reduced, but still visible to the naked eye.

In some implementations, the heatmap may be generated by rendering in groups (clusters), even though the actual representation range of the base heatmap does not meet the preset condition. Specifically, in a case where the actual representation range of the base heatmap does not meet the preset condition, the rendering range information of each target pixel point is updated according to the actual representation range of the base heatmap. The rendering image of each target pixel point is generated on the base heatmap according to the updated rendering range information of the target pixel point and the category color matching information configured for each category in advance to obtain the heatmap.

In a specific implementation, the mapping table between the preset representation ranges of the base heatmap and the rendering range information corresponding to the representation ranges may be obtained; and then, the corresponding rendering range information is selected from the mapping table as the updated rendering range information of each target pixel point according to the actual representation range of the base heatmap. Then, the sub-pixel value of each pixel point in the rendering range of the target pixel point may be generated according to the color matching mapping information of the category corresponding to the target pixel point. Taking one target pixel point as an example, other target pixel points are rendered in the same way. The transparency of each pixel point within the updated rendering range of the target pixel point is known, and the sub-pixel value, including a red sub-pixel value R, a green sub-pixel value G, and a blue sub-pixel value B, of each pixel point is determined from the color matching mapping information (as shown in FIG. 5) according to the transparency of each pixel point. Then, the rendering image of each target pixel point is generated according to the sub-pixel value and the transparency of each pixel point in the updated rendering range of the target pixel point. That is, the rendering image of each target pixel point in the updated rendering range is determined according to the parameters including R, G, B, Alpha of each pixel point. The rendering image of each target pixel point in the updated rendering range is generated on the base heatmap, thereby obtaining the heatmap.

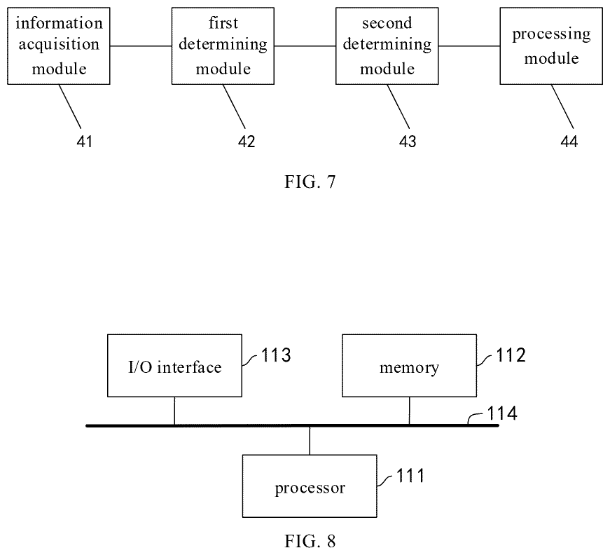

An embodiment of the present disclosure further provides a heatmap generation apparatus. FIG. 7 is a schematic diagram of a heatmap generation apparatus according to an embodiment of the present disclosure. As shown in FIG. 7, the heatmap generation apparatus includes an information acquisition module 41, a first determining module 42, a second determining module 43, and a processing module 44.

The information acquisition module 41 is configured to acquire an actual coordinate in a scene coordinate system and a pre-stored base heatmap. It should be noted that for the implementation process of the information acquisition module 41, reference may be made to the implementation process of the step S11.

The first determining module 42 is configured to convert the actual coordinate into a pixel coordinate to obtain a target pixel point. It should be noted that for the implementation process of the first determining module 42, reference may be made to the implementation process of the step S12.

The second determining module 43 is configured to cluster each target pixel point to obtain a target cluster, and generate category attribute information of the target cluster. It should be noted that for the implementation process of the second determining module 43, reference may be made to the implementation process of the step S13.

The processing module 44 is configured to generate a rendering image of each target pixel points on the base heatmap according to parameter information configured for each category in advance and the category attribute information of each target cluster, to obtain the heatmap. It should be noted that for the implementation process of the processing module 44, reference may be made to the implementation process of the step S14.

In some implementations, the second determining module 43 is specifically configured to determine a clustering condition of the target pixel points according to a predetermined coordinate conversion ratio and a preset clustering factor; and classify the target pixel points according to the clustering condition, to obtain the target cluster, and generate the category attribute information of the target cluster. It should be noted that for the implementation process of the second determining module 43, reference may be made to the implementation process of determining the target cluster in the heatmap generation method.

In some implementations, the second determining module 43 is specifically configured to take one target pixel point as a core pixel point, and judge whether another target pixel points exists in a coverage range of the core pixel point; where the coverage range is determined based on a predetermined coordinate conversion ratio and a preset clustering factor; and in a case where there is another target pixel point existed in the coverage range of the core pixel, take the another target pixel point as an updated core pixel and continuously traverse until no another target pixel point exists in the coverage range of the updated core pixel point; and cluster core pixel points in the traversal process into a same target cluster. It should be noted that for the implementation process of the second determining module 43, reference may be made to the implementation process of determining the target cluster in the heatmap generation method.

In some implementations, the second determining module 43 is specifically configured to generate the category attribute information of the target cluster according to the number of the target pixel points in the target cluster. It should be noted that for the implementation process of the second determining module 43, reference may be made to the implementation process of determining the category attribute information of the target cluster in the heatmap generation method.

In some implementations, the parameter information configured for each category in advance includes category color matching information and rendering range information. The processing module 44 is specifically configured to generate, in a case where an actual representation range of the base heatmap meets a preset condition, the rendering image of each target pixel point on the base heatmap based on the category attribute information of each target cluster and according to the category color matching information and the rendering range information configured for each category in advance to obtain the heatmap. It should be noted that for the implementation process of the processing module 44, reference may be made to the implementation process of determining the heatmap in the heatmap generation method.

In some implementations, the processing module 44 is specifically configured to generate color matching mapping information corresponding to each category according to the category color matching information configured for each category in advance; determine the rendering range of each target pixel point according to the rendering range information configured for each category in advance; determine, for the rendering range of each target pixel point, a rendering parameter of each pixel point in the rendering range according to a distance between each pixel point in the rendering range and the target pixel point and the rendering range information of the category corresponding to the target pixel point; generate, based on the category attribute information of each target cluster, the rendering image of each target pixel point on the base heatmap according to the rendering parameter of each pixel point in the rendering range of each target pixel point and the color matching mapping information corresponding to each category, to obtain the heatmap. It should be noted that for the implementation process of the processing module 44, reference may be made to the implementation process of determining the heatmap in the heatmap generation method.

In some implementations, the rendering parameter includes a transparency; the processing module 44 is specifically configured to determine, for the rendering range of each target pixel point, the transparency of each pixel point in the rendering range by using a preset formula according to the distance between each pixel point in the rendering range and the target pixel point and the rendering range information of the category corresponding to the target pixel point; the transparency of each pixel point in the rendering range is non-linearly changed as the distance between the pixel point and the target pixel point; a difference in transparency between two adjacent pixel points close to the target pixel point and having different distances from the target pixel point is smaller than that between two adjacent pixel points far from the target pixel point and having different distances from the target pixel point. It should be noted that for the implementation process of the processing module 44, reference may be made to the implementation process of determining the transparency in the heatmap generation method.

In some implementations, the processing module 44 is specifically configured to generate a sub-pixel value of each pixel point in the rendering range of the target pixel point according to the color matching mapping information of the category corresponding to the target pixel point; generate the rendering image of each target pixel point according to the sub-pixel value and the rendering parameter of each pixel point in the rendering range of the target pixel point. It should be noted that for the implementation process of the processing module 44, reference may be made to the implementation process of generating the rendering images in the heatmap generation method.

In some implementations, the parameter information configured for each category in advance includes the category color matching information and the rendering range information; the heatmap generation apparatus further includes a judgment module, where the judgment module is configured to determine a scaling factor in response to a scaling operation to the base heatmap, and determine whether an actual representation range of the scaled base heatmap meets a preset condition or not. It should be noted that for a specific implementation process of the judgment module, reference may be made to a specific implementation process of “determining whether the actual representation range of the scaled base heatmap meets the preset condition or not” in the heatmap generation method.

The processing module 44 is specifically configured to update the rendering range information configured for each category in advance and the pixel coordinate of each target pixel point according to the scaling factor in a case where the actual representation range of the scaled base heatmap meets the preset condition; and generate, based on the category attribute information of each target cluster, an updated rendering image of each target pixel point on the base heatmap according to the category color matching information configured for each category in advance, the updated rendering range information of each category and the updated pixel coordinate of each target pixel point, to obtain the heatmap. It should be noted that for the implementation process of the processing module 44, reference may be made to the implementation process of generating the heatmap in the heatmap generation method.

In some implementations, the processing module 44 is further configured to update the rendering range information of each target pixel point according to the actual representation range of the base heatmap in a case where the actual representation range of the base heatmap does not meet the preset condition; generate the rendering image of each target pixel point on the base heatmap according to the updated rendering range information of each target pixel point and preset color matching information of each target pixel point, to obtain the heatmap. It should be noted that for the implementation process of the processing module 44, reference may be made to the implementation process of generating the heatmap in the heatmap generation method.

In some implementations, the processing module 44 is specifically configured to obtain a plurality of preset specific representation ranges of the base heatmap and the rendering range information of the target pixel point corresponding to each specific representation range; select a part of specific representation ranges related to the actual representation range of the base heatmap from the specific representation ranges as a target representation range, and use the rendering range information corresponding to the target representation range as the target rendering range information; determine a linear interpolation parameter according to the target representation range and the target rendering range information; and update the rendering range information of each target pixel point according to the linear interpolation parameter and the actual representation range of the base heatmap. It should be noted that for the implementation process of the processing module 44, reference may be made to the implementation process of generating and updating rendering range information of the target pixel points in the heatmap generation method.

In some implementations, the parameter information configured for each category in advance includes category color matching information and rendering range information; the processing module 44 is configured to update the rendering range information of each target pixel point according to the actual representation range of the base heatmap in a case where the actual representation range of the base heatmap does not meet the preset condition; generate the rendering image of each target pixel point on the base heatmap according to the updated rendering range information of each target pixel point and the category color matching information configured for each category in advance to obtain the heatmap. It should be noted that for the implementation process of the processing module 44, reference may be made to the implementation process of generating the heatmap in the heatmap generation method.

In some implementations, the first determining module 42 is configured to determine the coordinate conversion ratio according to a calibration area in the real scene and a pre-stored coordinate thereof, and obtain the target pixel point according to the coordinate conversion ratio and the actual coordinate. It should be noted that for the implementation process of the first determining module 42, reference may be made to the implementation process of generating each target pixel point in the heatmap generation method.

FIG. 8 is a schematic diagram of a structure of a computer device according to an embodiment of the present disclosure. As shown in FIG. 8, an embodiment of the present disclosure provides a computer device including: one or more processors 111, a memory 112, one or more I/O interfaces 113. The memory 112 stores one or more programs that when executed by the one or more processors, cause the one or more processors to implement the heatmap generation method as in any one of the embodiments described above; the one or more I/O interfaces 113 are connected between the one or more processors 111 and the memory 112 and are configured to enable information interaction between the one or more processors 111 and the memory 112.

Each processor 111 is a device having a data processing capability, and includes, but is not limited to, a central processing unit (CPU) or the like; the memory 112 is a device having a data storage capability, and includes, but is not limited to, a random access memory (RAM, such as SDRAM, DDR, etc.), a read-only memory (ROM), an electrically erasable programmable read-only memory (EPROM), and FLASH; the one or more I/O interfaces (read/write interfaces) 113 are connected between the one or more processors 111 and the memory 112 and can implement the information interaction between the one or more processors 111 and the memory 112, and include, but are not limited to, a data bus or the like.

In some implementations, the processors 111, the memory 112, and the I/O interfaces 113 are interconnected by a bus 114, which in turn, are connected to other components of the computer device.

According to an embodiment of the present disclosure, there is also provided a non-transitory computer readable storage medium. The non-transitory computer readable storage medium has a computer program stored thereon, which when executed by a processor, implements the steps in the heatmap generation method as in any one of the embodiments described above.

In particular, according to embodiments of the present disclosure, the processes described above with reference to the flowcharts may be implemented as a computer software program. For example, an embodiment of the present disclosure includes a computer program product, including a computer program carried on a machine-readable medium; the computer program includes program codes for performing the method illustrated in the flowchart. In such embodiment, the computer program may be downloaded and installed from a network via a communication section, and/or installed from a removable medium. The above functions defined in the system of the present disclosure are performed when the computer program is executed by the central processing unit (CPU).

It should be noted that the non-transitory computer readable storage medium shown in the present disclosure may be a computer readable signal medium or a computer readable storage medium or any combination thereof. The computer readable storage medium may be, for example, but not limited to, an electronic, magnetic, optical, electromagnetic, infrared, or a semiconductor system, a semiconductor apparatus, or a semiconductor device, or any combination thereof. More specific examples of the computer readable storage medium may include, but are not limited to: an electrical connection having one or more wires, a portable computer diskette, a hard disk, a random access memory (RAM), a read-only memory (ROM), an erasable programmable read-only memory (erasable EPROM or flash memory), an optical fiber, a portable compact disc read-only memory (CD-ROM), an optical storage device, a magnetic storage device, or any suitable combination thereof. In the present disclosure, the computer readable storage medium may be any tangible medium that contains or stores programs for use by or in connection with an instruction execution system, apparatus, or device. In the present disclosure, the computer readable signal medium may include a propagated data signal with computer readable program codes embodied therein, for example, in baseband or as part of a carrier wave. Such a propagated data signal may take any of a variety of forms, including, but not limited to, electromagnetic signals, optical signals, or any suitable combination thereof. The computer readable signal medium may be any non-transitory computer readable storage medium other than the computer readable storage medium; the non-transitory computer readable storage medium may transmit, propagate, or transport programs for use by or in connection with an instruction execution system, apparatus, or device. The program codes embodied on the non-transitory computer readable storage medium may be transmitted through any suitable medium, including, but not limited to, wireless, wired, optical cable, RF (a radio frequency) or any suitable combination thereof.

The flowchart and block diagrams in the drawings illustrate architecture, functionality, and operation of possible implementations of a device, a method and a computer program product according to various embodiments of the present disclosure. In this regard, each block in the flowchart or block diagrams may represent a module, program segment(s), or a portion of a code, which includes one or more executable instructions for implementing specified logical function(s). It should also be noted that in some alternative implementations, functions noted in the blocks may occur out of the order noted in the drawings. For example, two blocks being successively connected may, in fact, be performed substantially concurrently, or the blocks may sometimes be performed in the reverse order, depending upon the functionality involved. It will also be noted that each block of the block diagrams and/or flowchart, and combinations of blocks in the block diagrams and/or flowchart, may be implemented by special purpose hardware-based systems that perform the specified functions or operations, or combinations of special purpose hardware and computer instructions.

Circuits or sub-circuits described in the embodiments of the present disclosure may be implemented by software or hardware. The described circuits or sub-circuits may also be provided in a processor, which may be described as: a processor, including: a receiving circuit and a processing circuit; the processing circuit includes a writing sub-circuit and a reading sub-circuit. Names of such circuits or sub-circuits do not limit the circuits or sub-circuits themselves in some cases. For example, the receiving circuit may also be described as “receiving a video signal”.

It should be understood that the above embodiments are merely exemplary embodiments adopted to explain the principles of the present disclosure, and the present disclosure is not limited thereto. It will be apparent to one of ordinary skill in the art that various changes and modifications may be made therein without departing from the spirit and scope of the present disclosure, and such changes and modifications also fall within the scope of the present disclosure.

1. A heatmap generation method, comprising:
acquiring an actual coordinate in a scene coordinate system and a pre-stored base heatmap;
converting the actual coordinate into a pixel coordinate to obtain a target pixel point;
clustering the target pixel point to obtain a target cluster, and generating category attribute information of the target cluster; and
generating a rendering image of the target pixel point on the base heatmap according to parameter information configured for respective categories in advance and the category attribute information of the target cluster to obtain a heatmap.

2. The heatmap generation method according to claim 1, wherein the clustering the target pixel point to obtain a target cluster and generating category attribute information of the target cluster comprises:
determining a clustering condition of the target pixel points according to a predetermined coordinate conversion ratio and a preset clustering factor; and
classifying the target pixel point according to the clustering condition to obtain the target cluster and generating the category attribute information of the target cluster.

3. The heatmap generation method according to claim 2, wherein the classifying the target pixel point according to the clustering condition to obtain the target cluster comprises:
taking one target pixel point as a core pixel point, and judging whether there is another target pixel point existed in a coverage range of the core pixel point; wherein the coverage range is determined based on the predetermined coordinate conversion ratio and the preset clustering factor; and
taking another target pixel point as an updated core pixel point to traverse until no another target pixel point exists in the coverage range of the updated core pixel point under the condition that there is another target pixel point existed in the coverage range of the core pixel point; and clustering the respective core pixel points in the traversal process into a same target cluster.

4. The heatmap generation method according to claim 1, wherein the generating the category attribute information of the target cluster comprises:
generating the category attribute information of the target cluster according to the number of target pixel points in the target cluster.

5. The heatmap generation method according to claim 1, wherein the parameter information configured for the respective categories in advance comprises category color matching information and rendering range information;
the generating a rendering image of the target pixel point on the base heatmap according to the parameter information configured for the respective categories in advance and the category attribute information of the target cluster to obtain the heatmap, comprises:
generating, in response to that an actual representation range of the base heatmap meets a preset condition and based on the category attribute information of the target cluster, the rendering image of the target pixel point on the base heatmap according to the category color matching information and the rendering range information configured for the respective categories in advance to obtain the heatmap,

6. The heatmap generation method according to claim 5, wherein the generating, based on the category attribute information of the target cluster, the rendering image of the target pixel point on the base heatmap according to the category color matching information and the rendering range information configured for the respective categories in advance to obtain the heatmap comprises:
generating color matching mapping information corresponding to the respective categories according to the category color matching information configured for the respective categories in advance;
determining the rendering range of the target pixel point according to the rendering range information configured for the respective categories in advance;
determining, for the rendering range of the target pixel point, a rendering parameter of the pixel point in the rendering range according to a distance between the pixel point in the rendering range and the target pixel point and the rendering range information of the category corresponding to the target pixel point; and
generating, based on the category attribute information of the target cluster, the rendering image of the target pixel point on the base heatmap according to the rendering parameter of the pixel point in the rendering range of the target pixel point and the color matching mapping information corresponding to the respective categories to obtain the heatmap.

7. The heatmap generation method according to claim 6, wherein the rendering parameter comprises a transparency;
the determining, for the rendering range of the target pixel point, the rendering parameter of the pixel point in the rendering range according to a distance between the pixel point in the rendering range and the target pixel point and the rendering range information of the category corresponding to the target pixel point comprises:
determining, for the rendering range of the target pixel point, the transparency of the pixel point in the rendering range by using a preset formula according to the distance between the pixel point in the rendering range and the target pixel point and the rendering range information of the category corresponding to the target pixel point; wherein
the transparency of the pixel point in the rendering range is non-linearly changed as the distance between the pixel point and the target pixel point; a difference in transparency between two adjacent pixels close to the target pixel point and having different distances from the target pixel point is smaller than that between two adjacent pixels far from the target pixel point and having different distances from the target pixel point.

8. The heatmap generation method according to claim 6, wherein the generating the rendering image of the target pixel point comprises:
generating a sub-pixel value of the pixel point in the rendering range of the target pixel point according to the color matching mapping information of the category corresponding to the target pixel point; and
generating the rendering image of the target pixel point according to the sub-pixel value and the rendering parameter of the pixel point in the rendering range of the target pixel point.

9. The heatmap generation method according to claim 1, wherein the parameter information configured for the respective categories in advance comprises category color matching information and rendering range information;
the heatmap generation method further comprises: determining a scaling factor in response to a scaling operation to the base heatmap, and determining whether an actual representation range of the scaled base heatmap meets a preset condition or not;
the generating the rendering image of the target pixel point on the base heatmap according to parameter information configured for the respective categories in advance and the category attribute information of the target cluster to obtain the heatmap comprises:
updating the rendering range information configured for the respective categories in advance and the pixel coordinate of the target pixel point according to the scaling factor in response to that the actual representation range of the scaled base heatmap meets the preset condition; and
generating, based on the category attribute information of the target cluster, an updated rendering image of the target pixel point on the base heatmap according to the category color matching information configured for the respective categories in advance, the updated rendering range information of the respective categories and the updated pixel coordinate of the target pixel point to obtain the heatmap.

10. The heatmap generation method according to claim 1, further comprising:
updating, in response to that an actual representation range of the base heatmap does not meet the preset condition, the rendering range information of the target pixel point according to the actual representation range of the base heatmap; and
generating the rendering image of the target pixel point on the base heatmap according to the updated rendering range information of the target pixel point and the preset color matching information of the target pixel point to obtain the heatmap.

11. The heatmap generation method according to claim 10, wherein the updating the rendering range information of the target pixel point according to the actual representation range of the base heatmap comprises:
acquiring a plurality of preset specific representation ranges of the base heatmap and the rendering range information of the target pixel point corresponding to the respective specific representation ranges;
selecting a part of specific representation ranges related to the actual representation range of the base heatmap from the specific representation ranges as a target representation range, and using the rendering range information corresponding to the target representation range as target rendering range information;
determining a linear interpolation parameter according to the target representation range and the target rendering range information; and
updating the rendering range information of the target pixel point according to the linear interpolation parameter and the actual representation range of the base heatmap.

12. The heatmap generation method according to claim 1, wherein the parameter information configured for the respective categories in advance comprises category color matching information and rendering range information;
the generating a rendering image of the target pixel point on the base heatmap according to parameter information configured for the respective categories in advance and the category attribute information of the target cluster to obtain a heatmap comprises:
updating, in response to that an actual representation range of the base heatmap does not meet a preset condition, the rendering range information of the target pixel point according to the actual representation range of the base heatmap; and
generating the rendering image of the target pixel point on the base heatmap according to the updated rendering range information of the target pixel point and the category color matching information configured for the respective categories in advance to obtain the heatmap.

13. The heatmap generation method according to claim 1, wherein the converting the actual coordinate into a pixel coordinate to obtain a target pixel point comprises:
determining a coordinate conversion ratio according to a calibration area in the real scene and a pre-stored coordinate of the calibration area; and
obtaining the target pixel point according to the coordinate conversion ratio and the actual coordinate.

14. A heatmap generation apparatus, comprising:
an information acquisition module configured to acquire an actual coordinate in a scene coordinate system and a pre-stored base heatmap;
a first determining module configured to convert the actual coordinate into a pixel coordinate to obtain a target pixel point;
a second determining module configured to cluster the target pixel point to obtain a target cluster, and generate category attribute information of the target cluster; and
a processing module configured to generate a rendering image of the target pixel point on the base heatmap according to parameter information configured for respective categories in advance and the category attribute information of the target cluster to obtain a heatmap.

15. A computer device, comprising: a processor, a memory and a bus, wherein the memory stores machine-readable instructions executable by the processor; the processor and the memory are communicated with each other over the bus when the computer device is operating; the machine-readable instructions, when executed by the processor, perform the steps of the heatmap generation method according to claim 1.

16. A non-transitory computer readable storage medium, wherein the non-transitory computer readable storage medium has stored thereon a computer program, which, when executed by a processor, performs the steps of the heatmap generation method according to claim 1.

17. The heatmap generation method according to claim 2, wherein the generating the category attribute information of the target cluster comprises:
generating the category attribute information of the target cluster according to the number of target pixel points in the target cluster.

18. The heatmap generation method according to claim 3, wherein the generating the category attribute information of the target cluster comprises:
generating the category attribute information of the target cluster according to the number of target pixel points in the target cluster.

19. A computer device, comprising: a processor, a memory and a bus, wherein the memory stores machine-readable instructions executable by the processor; the processor and the memory are communicated with each other over the bus when the computer device is operating; the machine-readable instructions, when executed by the processor, perform the steps of the heatmap generation method according to claim 2.

20. A non-transitory computer readable storage medium, wherein the non-transitory computer readable storage medium has stored thereon a computer program, which, when executed by a processor, performs the steps of the heatmap generation method according to claim 2.
